(19) United States
(12) Patent Application Publication
(10) Pub. No.: US 2008/0277175 A1
(43) Pub. Date: Nov. 13, 2008

(54) Fuel Cell Hybrid-Electric Heavy-Duty Vehicle Drive System and Method

(75) Inventors: Tavin M. Tyler, San Diego, CA (US); Brian Douglas Moran, La Mesa, CA (US)

Correspondence Address: PROCOPIO, CORY, HARGREAVES & SAVITCH LLP, 530 B STREET, SUITE 2100, SAN DIEGO, CA, 92101, US

(73) Assignee: ISE CORPORATION, Poway, CA (US)

(21) Appl. No.: 11/745,022

(22) Filed: May 7, 2007

(51) Int. Cl. B60L 11/18; B60L 11/16; H02P 3/14; H02J 7/34; H02J 7/14; B60L 1/12

(52) U.S. Cl. 180/65.3; 701/22; 318/376; 320/101; 307/10.1

(57) ABSTRACT

A system and a method that provides fuel cell and energy storage hybrid-electric propulsion and control for a heavy-duty vehicle over 10,000 pounds GVWR. Power output is supplied from a fuel cell system to a high-power intermediate DC bus through a fuel cell DC/DC converter. Power output is supplied from an energy storage system to the high-power intermediate DC bus through a separate energy storage fuel cell DC/DC converter. The received power is combined on the high-power intermediate DC bus to create a stable voltage. The stable voltage from the high-power intermediate DC bus is supplied to one or more electric motors/generators to accelerate the heavy duty vehicle.

### FIELD OF THE INVENTION

The field of the invention relates to heavy-duty vehicle hybrid-electric drive systems powered by a fuel cell and methods for controlling such systems.

### BACKGROUND OF THE INVENTION

Fuel cell and battery electric technologies are considered the only practical choices for providing zero emission solutions to power heavy-duty transit buses. The energy storage of advanced batteries could potentially supply enough energy to provide an adequate bus driving range, but acceptable advanced batteries are currently still in development and not yet proven.

Therefore, currently, fuel cell technology is the only option to provide zero emission solutions to power heavy-duty vehicles and meet acceptable ranges of travel before having to refuel. Using fuel cells as the only vehicle power source presents various implementation challenges. First, the overall fuel cell vehicle efficiency is limited because heavy-duty vehicles operate over a wide range of power demands and fuel cells maintain optimal efficiency only over a smaller range of power outputs. Fuel cells typically have a slow transient power response that abruptly reduces the output voltage with an increase in output current. Further, the mechanical output power of the vehicle electric propulsion motors drops as the input power supply voltage drops at high speed and high acceleration. The slow response of fuel cells to a power change is due to the fuel cell requirement for a specific ratio between hydrogen and oxygen to generate electrical energy from a chemical reaction. Finally, fuel cells only produce power and cannot store the energy created by electro magnetic braking regeneration power from the propulsion motor/generator.

### SUMMARY OF THE INVENTION

To overcome the slow power change response of fuel cells, battery or ultracapacitor secondary energy storage is used to supply additional power, in combination with fuel cells. This combined fuel cell/battery hybrid-electric configuration, or “hybridization,” offers a solution for fuel cell technology to meet the major goals of fuel cell life, vehicle range, and cost in a heavy-duty public transportation bus and other heavy-duty vehicles. The fuel cell experiences less “power” stress, vehicle range between refueling increases with increased fuel economy provided by the recycling of braking regeneration energy, and a smaller less costly fuel cell pack can be used and still meet the vehicle maximum power requirements.

Aspects of the present invention involve a system and a method for combining and controlling the amounts of power supplied from fuel cell(s) through a DC/DC converter and from an energy storage device through another, separate DC/DC converter. The combined power output is delivered onto an intermediate high-voltage power bus in an inverter/controller and supplied to a propulsion motor/generator.

In the system aspect of the invention, the system includes fuel cell(s), DC/DC converters, an energy storage battery/pack, inverter/controllers and, and one or more computer controllers for estimating the required vehicle power and controlling the functions described herein. The one or more computer controllers selectively control a battery only (EV) propulsion state and fuel cell hybrid-electric (HEV) propulsion state as well as controlling battery recharging from braking regeneration during vehicle deceleration.

The fuel cell(s) are used as the main power source and an energy storage battery/pack is used as a secondary power source. Each power source has its energy flow through a separate DC/DC converter before combining the power output from both the fuel cell(s) and battery on a high-voltage high power intermediate bus to supply a stable voltage to electric drive motors of the heavy duty vehicle. Having both the fuel cell(s) and battery/pack connected through their own separate DC/DC converter maintains a stable voltage at the input of the inverter/controller for the drive motors and allows the vehicle to perform at higher power efficiencies for longer periods of time.

The “Hybridization” of providing two separate power sources relaxes the dynamic requirements placed on the fuel cell system and allows the fuel cell(s) to operate at optimum efficiency. Adding power from the energy storage system to augment power from the fuel cell(s) for rapid accelerations helps in relieving the stress on, and extending the life of, the fuel cells. The hybrid-electric design provides an increase in efficiency due to braking regeneration energy recovery, storage, and recycling. The recovery of braking energy to be reused for acceleration and hill climbing helps to maximize the vehicle operating range with a given on-board hydrogen storage tank. Also, the hybrid configuration allows downsizing of the required fuel cell output power rating accompanied by a notable cost reduction for the fuel cell(s).

In the method aspect of the invention, the method combines the power from a fuel cell and an energy storage, delivers the combined power to an intermediate high-voltage power bus in an inverter/controller and supplies the power to the propulsion motor/generator. In this aspect of the invention, the system components include fuel cell(s), DC/DC converters, an energy storage battery/pack, inverter/controllers and one or more computer controllers for estimating the required vehicle power and controlling the functions described herein. The one or more computer controllers selectively control a battery only (EV) propulsion state and fuel cell hybrid-electric (HEV) propulsion state as well as controlling battery recharging from braking regeneration during vehicle deceleration.

Another aspect of the invention involves a heavy-duty vehicle hybrid-electric drive system for a heavy-duty vehicle over 10,000 pounds gross vehicle weight (GVWR). The system includes a fuel storage including a fuel cell fuel; a fuel cell system coupled to the fuel storage to receive fuel; a fuel cell DC/DC converter coupled to the fuel cell system for providing electric power; an energy storage system separate from the fuel cell system; an energy storage DC/DC converter coupled to the energy storage system for supplementing electric power provided by the fuel cell, and separate from the fuel cell DC/DC converter; one or more electric motors/generators that consume supplied electric power from at least one of the fuel cell system and the energy storage system to accelerate the heavy duty vehicle and generate electric power upon deceleration of the vehicle; and one or more control computers for combining power from the fuel cell system and the energy storage system to be supplied to the one or more electric motors/generators, and controlling the one or more electric motors/generators.

A further aspect of the invention involves a method of using a heavy-duty vehicle hybrid-electric drive system for a heavy-duty vehicle over 10,000 pounds GVWR. The method includes supplying output power from a fuel cell system to a high-power intermediate DC bus through a fuel cell DC/DC converter; supplying power output from an energy storage system to the high-power intermediate DC bus through a separate energy storage fuel cell DC/DC converter; receiving and combining the power output from the fuel cell system and the energy storage system on the high-power intermediate DC bus to create a stable voltage; and supplying the stable voltage from the high-power intermediate DC bus to one or more electric motors/generators to accelerate the heavy duty vehicle.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1 is a block diagram of an embodiment of a heavy-duty vehicle hybrid-electric drive system for a heavy-duty vehicle.

FIG. 2 is an electrical schematic of an embodiment of a heavy-duty vehicle hybrid-electric drive system for a heavy-duty vehicle.

FIG. 3 is a state diagram of exemplary modes of operation of the heavy-duty vehicle hybrid-electric drive system for a heavy-duty vehicle.

FIG. 4 is a block diagram illustrating an exemplary computer system that may be used in connection with the various embodiments described herein.

### DETAILED DESCRIPTION OF A PREFERRED EMBODIMENT

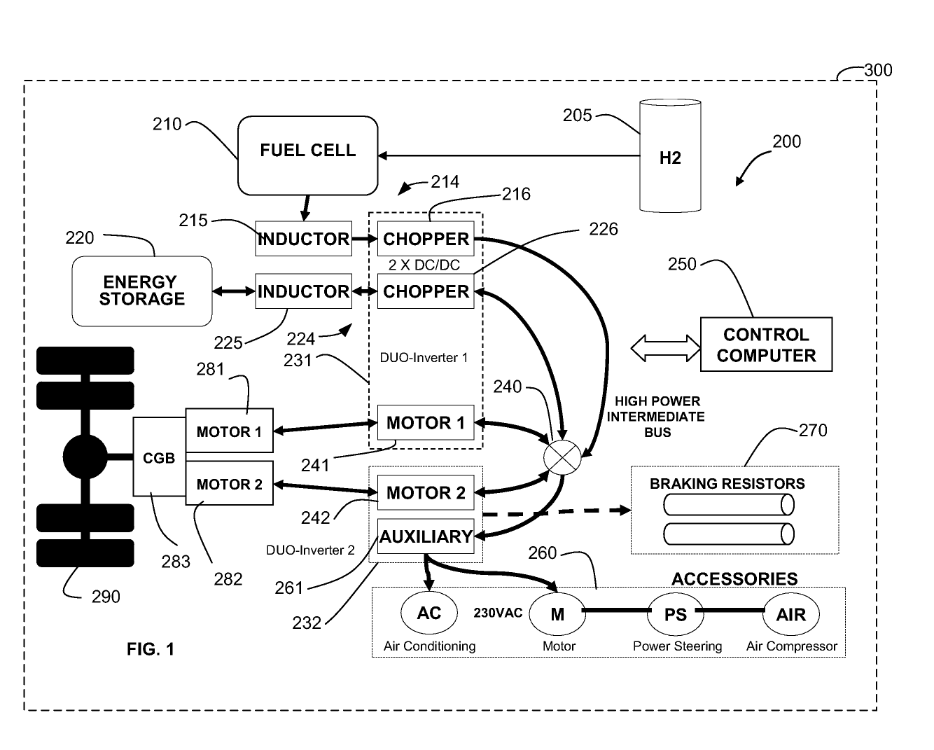

With reference to FIGS. 1-3, and initially FIG. 1, an embodiment of a heavy-duty vehicle hybrid-electric drive system (“system”) 200 for a heavy-duty vehicle 300 will be described. As used herein, a heavy-duty vehicle is a vehicle over 10,000 pounds GVWR (Gross Vehicle Weight Rating). The heavy-duty vehicle hybrid-electric drive system 200 includes a fuel cell used as the main power source and an energy storage battery as a secondary power source. Each power source has its energy flow through a separate DC/DC converter before combining the power output from both the fuel cell and battery on a high-voltage high power intermediate bus to supply a stable voltage to the electric drive motors. Having both the fuel cell and battery connected through their own separate DC/DC converter maintains a stable voltage at the input of the inverter/controller for the drive motors, relaxes the dynamic requirements placed on the fuel cell system, allows the fuel cell to operate at optimum efficiency and allows the vehicle to perform at higher power efficiencies for longer periods of time.

The basic components of system 200 include fuel storage 205 (e.g., including hydrogen gas), fuel cell system (one or more proton exchange membrane (PEM) fuel cells) 210, separate DC/DC converters 214, 224, an energy storage system (e.g., at least one of a battery pack, an ultracapacitor pack, a flywheel energy storage system, and any combination of batteries, ultracapacitors, and flywheels) 220, inverter/controllers 231, 232, high power, high voltage intermediate bus 240, one or more electric drive motors/generators 281, 282 and one or more computer controllers 250 for estimating the required vehicle power and controlling the functions described herein.

An exemplary method of using the heavy-duty vehicle hybrid-electric drive system 200 will now be described. Compressed hydrogen fuel is stored and supplied from a fuel storage (e.g., high pressure tank) 205 to the fuel cell(s) 210. The electrical power output of the fuel cell(s) 210 passes through high-power DC/DC converter 214 (e.g., inductor 215 and “chopper” solid state switches 216) to deliver a stepped-up constant voltage to the high-power, high-voltage intermediate bus 240. Similarly, power from the energy storage 220 passes through separate high-power DC/DC converter 224 (e.g., inductor 225 and chopper 226) to the high-power bus 240. By way of example, but not limitation, the energy storage 220 is one of a single and a plurality of battery packs, ultracapacitor packs, a combination of battery packs and ultracapacitor packs, and a combination battery and ultracapacitor pack.

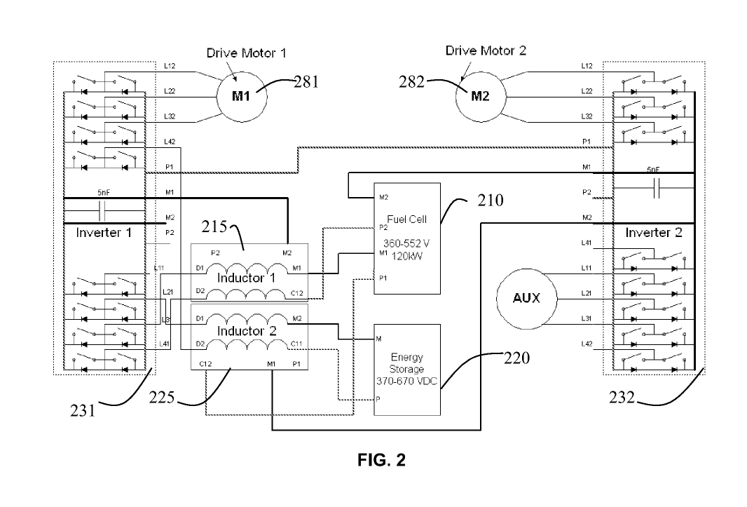

The two chopper circuits 216, 226 and controller 241 for drive motor #1 281 are made from the switching actions of IGBT (Insolated Gate Bipolar Transistors) phases contained within DUO-Inverter #1 231. The switching actions of the IGBT phases within DUO-Inverter #2 implement controller 242 for drive motor #2 282 and auxiliary inverter 261 that supplies 230 volts 3-phase AC power for vehicle accessories 260 (e.g., an air conditioner, a hydraulic pump, an air compressor, one or more fans, one or more blowers, a water pump, an oil pump, a fuel pump, a vacuum pump, and/or an electric hydraulic actuator). Electrical energy is supplied through the controllers 241, 242 to the respective drive motor #1 281 and drive motor #2 282, and the mechanical outputs of drive motor #1 281 and drive motor #2 282 are summed in combining gear box (CGB) 283, which delivers the mechanical power to vehicle traction drive system 290 of heavy-duty vehicle 300 to propel and accelerate the vehicle 300. The high-power intermediate bus 240 exists as a conducting current path within the two inverters 231, 232 and the wire cable connections shown in FIG. 2.

In another embodiment, multiple energy sources/systems, each with their own DC/DC converter, is provided in the system 200.

In a further optional embodiment of the invention, one of a single and a plurality of braking resistors 270 (e.g., liquid-cooled braking resistor(s)) is switched, by means of IGBT phases within one of DUO-Inverter #1 231, DUO-Inverter #2 232, and both DUO-Inverter #1 231 and DUO-Inverter #2 232, onto the high power bus 240 to dissipate excess braking regeneration power, which cannot be stored in the energy storage 220, from the drive motors 281, 282 during vehicle deceleration.

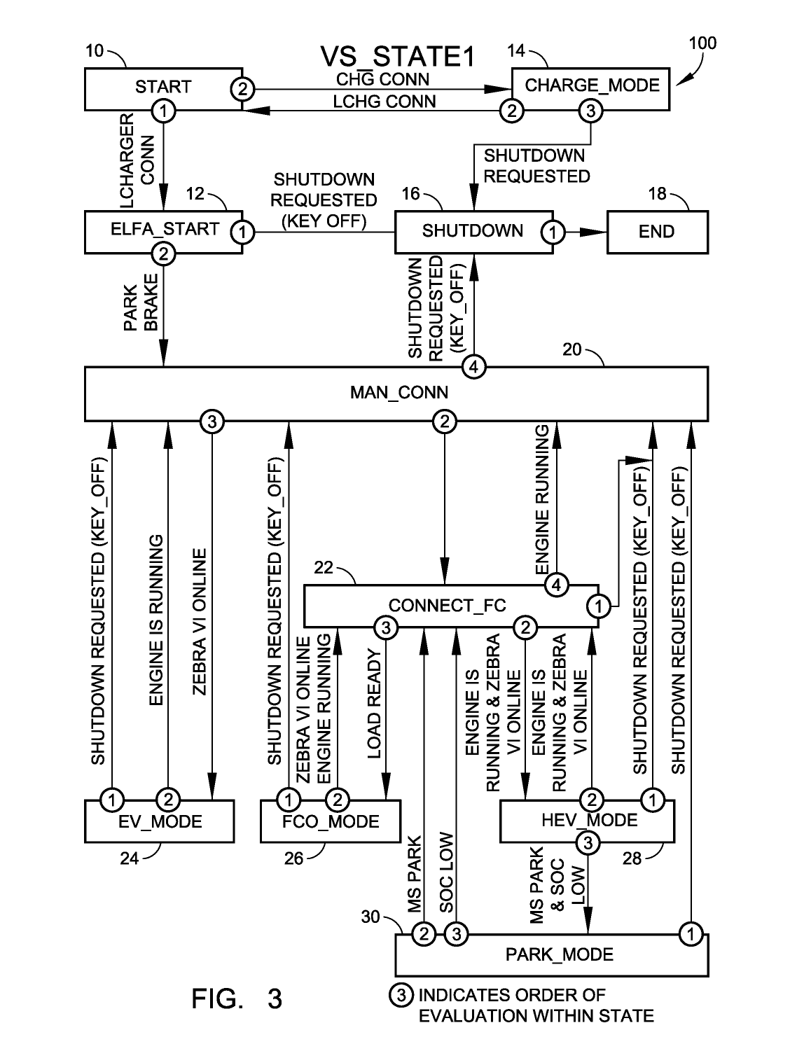

With reference to FIG. 2, the plus (P) and minus (M) connections identify the DC electrical current paths of an embodiment of the fuel cell 210 and energy storage 220 and, as shown, are routed through the inductors 215, 225 that form the basis of the separate “choppered” DC/DC converters 214, 224 (FIG. 3). This provides a steady voltage on the intermediate bus 240 to provide the ability for the motors 281, 282 to pull power for a longer period of time.

With reference to FIG. 3, an exemplary control process 100 for the heavy-duty vehicle hybrid-electric drive system 200 will be described. The control process 100 is illustrated as a state diagram showing exemplary modes of operation of the heavy-duty vehicle hybrid-electric drive system 200. The control system 100 is described by a number of states that start at “START” state 10 and end at “END” state 18. At the beginning of a control transfer path the numbers within the circles indicate the order of decision evaluation within the control state.

At START state 10 a decision is made whether to go to the CHARGE MODE state 14 or the ELFA START mode state 12. In the CHARGE MODE state 14 the batteries 220 are plugged into external power for charging. At the conclusion of the charging process a decision is made to return to the START state 10 or proceed to the SHUTDOWN state 16 and thence to the END state 18. To turn on the vehicle 300 from the START state 10 the control proceeds to the ELFA START state 12. At ELFA START state 12 the vehicle 300 is turned on by energizing all the electrical circuits. From the ELFA START state 12 the control proceeds to either the SHUTDOWN state 16 if a key off detection has requested a shutdown, or the MANUAL CONTROL state 20 for vehicle operation. From the MANUAL CONTROL state 20 there are three possible choices. A key off detection moves control to the SHUTDOWN state 16; otherwise, the operator selects either an all-electric mode where the control proceeds to ELECTRIC VEHICLE MODE state 24, or selects one of the fuel cell modes where the control proceeds to CONNECT FUEL CELL state 22.

In the ELECTRIC VEHICLE MODE state 24 the vehicle 300 operates without the fuel cell 210 using the energy storage 220 only until all-electric only operation is turned off and control returns to MANUAL CONTROL state 20.

Once the fuel cell 210 is running in CONNECT FUEL CELL control state 22 there are four possibilities. A key off detection returns control to the MANUAL CONTROL state 20. The standard choice is to select hybrid operation where control proceeds to HYBRID ELECTRIC VEHICLE MODE state 28. A back up selection is to operate without the energy storage 220 using the fuel cell 210 only where the control proceeds to FUEL CELL ONLY MODE state 26. The last choice from CONNECT FUEL CELL state 22 is simply to disconnect the fuel cell 210 and return the control back to the MANUAL CONTROL state 20.

At HYBRID ELECTRIC VEHICLE MODE control state 28 the vehicle 300 operates using both the fuel cell 210 and the energy storage 220 to propel the vehicle 300. In the event of an immediate shutdown request from a key off detection the control returns to MANUAL CONTROL state 20. Standby operation, such as happens with a stopped vehicle, returns control to the CONNECT FUEL CELL state 22. When the vehicle 300 is actually parked, the control proceeds to the PARK MODE state 30 where the energy state of charge (SOC) is monitored. From the PARK MODE state 30 the vehicle 300 can be shutdown (key off detection), where control returns to MANUAL CONTROL state 20; or go to standby operation by returning control to CONNECT FUEL CELL state 22 by path 2 (vehicle parked) or path 3 (SOC low).

At FUEL CELL ONLY MODE state 26 the vehicle 300 is propelled only by the energy from the fuel cell 210 and the energy storage 220 is off line. As in the other propulsion modes, an immediate shutdown request from a key off detection returns the control to MANUAL CONTROL state 20. Otherwise, once the energy storage 220 is ready to be reconnected the control returns to CONNECT FUEL CELL state 22.

Thus, the heavy-duty vehicle hybrid-electric drive system 200 includes fuel cell system 210 used as the main power source and energy storage system 220 as a secondary power source. Each power source has its energy flow through separate DC/DC converters 214, 224 before combining the power output from both the fuel cell system 210 and energy storage system 220 on high-voltage high power intermediate bus 240 to supply a stable voltage to the electric drive motors 281, 282. Having both the fuel cell system 210 and energy storage system 220 connected through their own separate DC/DC converter 214, 224 maintains a stable voltage at the input of the inverter/controller 241, 242 for the drive motors 281, 282 and allows the vehicle 300 to perform at higher power efficiencies for longer periods of time.

The “Hybridization” of providing two separate power sources relaxes the dynamic requirements placed on the fuel cell system 210 and allows the fuel cell system 210 to operate at optimum efficiency. Adding power from the energy storage system 220 to augment power from the fuel cell system 210 for rapid accelerations helps in relieving the stress and extending the life of fuel cells. The hybrid-electric design provides an increase in efficiency due to braking regeneration energy recovery, storage, and recycling. The recovery of braking energy to be reused for acceleration and hill climbing helps to maximize the vehicle operating range with a given on-board hydrogen storage tank. Also, the hybrid configuration allows downsizing of the required fuel cell output power rating accompanied by a notable cost reduction for the fuel cell.

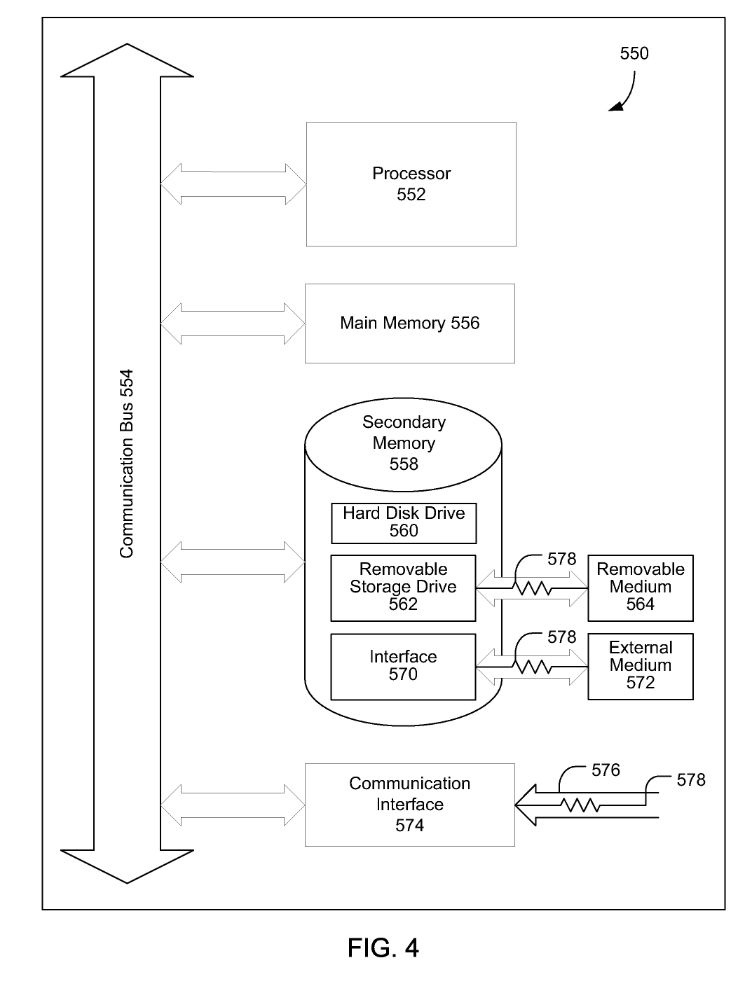

FIG. 4 is a block diagram illustrating an exemplary computer system 550 that may be used in connection with the various embodiments described herein. For example, the computer system 550 (or various components or combinations of components of the computer system 550) may be used in conjunction with the one or more control computers 250, controllers 241, 242, or to control the functions described herein. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Ram bus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A heavy-duty vehicle hybrid-electric drive system for a heavy-duty vehicle over 10,000 pounds GVWR, comprising:
a fuel storage including a fuel cell fuel;
a fuel cell system coupled to the fuel storage to receive fuel;
a fuel cell DC/DC converter coupled to the fuel cell system for providing electric power;
an energy storage system separate from the fuel cell system;
an energy storage DC/DC converter coupled to the energy storage system for supplementing electric power provided by the fuel cell, and separate from the fuel cell DC/DC converter;
one or more electric motors/generators that consume supplied electric power from at least one of the fuel cell system and the energy storage system to accelerate the heavy duty vehicle and generate electric power upon deceleration of the vehicle;
one or more control computers for combining power from the fuel cell system and the energy storage system to be supplied to the one or more electric motors/generators, and controlling the one or more electric motors/generators.

2. The system of claim 1, wherein the fuel cell fuel is hydrogen gas.

3. The system of claim 1, wherein the fuel cell system includes one or more proton exchange membrane (PEM) fuel cells.

4. The system of claim 1, wherein the energy storage includes at least one of a battery pack, an ultracapacitor pack, a flywheel energy storage system, and any combination of batteries, ultracapacitors, and flywheels.

5. The system of claim 1, wherein the fuel cell DC/DC converter and the energy storage DC/DC converter include one or more reactive inductors and one or more switched IGBTs in a choppered configuration.

6. The system of claim 1, further including a DC power bus and an IGBT inverter coupled to the DC power bus to produce AC power for vehicle accessories.

7. The system of claim 6, further including at least one of the following vehicle accessories coupled to the IGBT inverter: an air conditioner, a hydraulic pump, an air compressor, one or more fans, one or more blowers, a water pump, an oil pump, a fuel pump, a vacuum pump, and an electric hydraulic actuator.

8. The system of claim 1, further including one or more IGBT control switches coupled to the one or more electric motors/generators, and the energy storage system is recharged by deceleration braking regeneration energy from the one or more electric motors/generators being transmitted back through the one or more IGBT control switches and the energy storage DC/DC converter.

9. The system of claim 1, further including a high-power intermediate DC bus coupling the fuel cell system, the fuel cell DC/DC converter, the energy storage system, and the energy storage DC/DC converter, and the energy storage system is rechargeable by the fuel cell system through the fuel cell DC/DC converter, the high-power intermediate DC bus, and the energy storage DC/DC converter.

10. The system of claim 1, further including a high-power intermediate DC bus, one or more braking resistors, and one or more IGBT switches coupling the one or more braking resistors to the high-power intermediate DC bus to dissipate deceleration braking regeneration energy.

11. The system of claim 10, wherein the one or more braking resistors are liquid cooled.

12. The system of claim 1, wherein the one or more control computers include a state based control system that monitors control state statuses to determine when and where to pass control to a next state.

13. The system of claim 12, wherein each state includes an order for evaluating choices of passing control to the next state.

14. The system of claim 12, wherein the monitored statuses include one or more of a key switch, an energy storage SOC, a voltage of a high-power intermediate DC bus, control switch positions, operation of IGBT switches, operator accelerator and brake pedals, fuel cell output, fuel level, coolant level, and temperatures and pressures throughout system.

15. The system of claim 12, wherein the control states include an electric vehicle mode, a fuel cell only mode, a hybrid-electric mode, and a park mode.

16. The system of claim 12, wherein the control states include a charge mode wherein the energy storage system is charged from an external power source.

17. The system of claim 1, wherein the energy storage system includes one or more batteries chargeable from an external power source.

18. The system of claim 1, further including a high-power intermediate DC bus connectable to an external power load.

19. The system of claim 1, further including an auxiliary IGBT inverter and a high-power intermediate DC bus, and the auxiliary IGBT inverter is configured to develop AC power from DC power of the high-power intermediate DC bus and the AC power is connectable to an external power load.

20. A method of using a heavy-duty vehicle hybrid-electric drive system for a heavy-duty vehicle over 10,000 pounds GVWR, comprising:
supplying power output from a fuel cell system to a high-power intermediate DC bus through a fuel cell DC/DC converter;
supplying power output from an energy storage system to the high-power intermediate DC bus through a separate energy storage DC/DC converter;
receiving and combining the power output from the fuel cell system and the energy storage system on the high-power intermediate DC bus to create a stable voltage;
supplying the stable voltage from the high-power intermediate DC bus to one or more electric motors/generators to accelerate the heavy duty vehicle.

21. The method of claim 20, wherein the fuel cell fuel is hydrogen gas and further including receiving hydrogen gas by the fuel cell system.

22. The method of claim 20, wherein the fuel cell system includes one or more proton exchange membrane (PEM) fuel cells and supplying power output from an energy storage system includes supplying power output from one or more proton exchange membrane (PEM) fuel cells to a high-power intermediate DC bus through a fuel cell DC/DC converter.

23. The method of claim 20, wherein the energy storage includes at least one of a battery pack, an ultracapacitor pack, a flywheel energy storage system, and any combination of batteries, ultracapacitors, and flywheels, and supplying power output from an energy storage system includes supplying power output from at least one of a battery pack, an ultracapacitor pack, a flywheel energy storage system, and any combination of batteries, ultracapacitors, and flywheels to the high-power intermediate DC bus through a separate energy storage DC/DC converter.

24. The method of claim 20, wherein the fuel cell DC/DC converter and the energy storage DC/DC converter include one or more reactive inductors and one or more switched IGBTs in a choppered configuration; supplying power output from a fuel cell system includes supplying power output from a fuel cell system to a high-power intermediate DC bus through a fuel cell DC/DC converter including one or more reactive inductors and one or more switched IGBTs; and supplying power output from an energy storage system includes supplying power output from an energy storage system to the high-power intermediate DC bus through a separate energy storage DC/DC converter including one or more reactive inductors and one or more switched IGBTs.

25. The method of claim 20, further including a DC power bus and an IGBT inverter coupled to the DC power bus to produce AC power for vehicle accessories, and further including supplying AC power to power vehicle accessories through the DC power bus and an IGBT inverter.

26. The method of claim 25, further including at least one of the following vehicle accessories coupled to the IGBT inverter: an air conditioner, a hydraulic pump, an air compressor, one or more fans, one or more blowers, a water pump, an oil pump, a fuel pump, a vacuum pump, and an electric hydraulic actuator, and supplying AC power to power vehicle accessories includes powering at least one of an air conditioner, a hydraulic pump, an air compressor, one or more fans, one or more blowers, a water pump, an oil pump, a fuel pump, a vacuum pump, and an electric hydraulic actuator through the DC power bus and an IGBT inverter.

27. The method of claim 20, further including one or more IGBT control switches coupled to the one or more electric motors/generators, and the energy storage system is recharged by deceleration braking regeneration energy from the one or more electric motors/generators being transmitted back through the one or more IGBT control switches and the energy storage DC/DC converter, and further including recharging the energy storage system by deceleration braking regeneration energy from the one or more electric motors/generators being transmitted back through the one or more IGBT control switches and the energy storage DC/DC converter.

28. The method of claim 20, further including a high-power intermediate DC bus coupling the fuel cell system, the fuel cell DC/DC converter, the energy storage system, and the energy storage DC/DC converter, and the energy storage system is rechargeable by the fuel cell system through the fuel cell DC/DC converter, the high-power intermediate DC bus, and the energy storage DC/DC converter, and further including recharging the energy storage system by the fuel cell system through the fuel cell DC/DC converter, the high-power intermediate DC bus, and the energy storage DC/DC converter.

29. The method of claim 20, further including a high-power intermediate DC bus, one or more braking resistors, and one or more IGBT switches coupling the one or more braking resistors to the high-power intermediate DC bus to dissipate deceleration braking regeneration energy, and further including dissipating deceleration braking regeneration energy through the one or more braking resistors.

30. The method of claim 29, wherein the one or more braking resistors are liquid cooled, and further including cooling the braking resistors with a liquid cooling system.

31. The method of claim 20, wherein the one or more control computers include a state based control system that monitors control state statuses to determine when and where to pass control to a next state, and further including monitoring control state statuses with the state based control system to determine when and where to pass control to a next state.

32. The method of claim 31, wherein the monitored statuses include one or more of a key switch, an energy storage SOC, a voltage of a high-power intermediate DC bus, control switch positions, operation of IGBT switches, operator accelerator and brake pedals, fuel cell output, fuel level, coolant level, and temperatures and pressures throughout system, and monitoring includes monitoring one or more of a key switch, an energy storage SOC, a voltage of a high-power intermediate DC bus, control switch positions, operation of IGBT switches, operator accelerator and brake pedals, fuel cell output, fuel level, coolant level, and temperatures and pressures throughout system.

33. The method of claim 31, wherein the control states include an electric vehicle mode, a fuel cell only mode, a hybrid-electric mode, and a park mode, and monitoring includes monitoring with the state based control system that monitors an electric vehicle mode, a fuel cell only mode, a hybrid-electric mode, and a park mode.

34. The method of claim 31, wherein the control states include a charge mode wherein the energy storage system is charged from an external power source, and further including charging the energy storage system from an external power source.

35. The method of claim 20, further including a high-power intermediate DC bus connectable to an external power load, and further including supplying power to the external power load with the high-power intermediate DC bus.

36. The method of claim 20, further including an auxiliary IGBT inverter and a high-power intermediate DC bus, and the auxiliary IGBT inverter is configured to develop AC power from DC power of the high-power intermediate DC bus and the AC power is connectable to an external power load, and further including supplying AC power to the external power load through the auxiliary IGBT inverter.
